(19) United States
(12) Patent Application Publication
(10) Pub. No.: US 2020/0369851 A1
(43) Pub. Date: Nov. 26, 2020

(54) High Resistivity Rubber Compositions Comporising Oxidized Carbon Bkack

(71) Applicant: Birla Carbon U.S.A., Inc., Marietta, GA (US)

(72) Inventors: Charles R HERD, Woodstock, GA (US); Zachary A. COMBS, Woodstock, GA (US); Lewis B TUNNICLIFFE, Marietta, GA (US)

(73) Assignee: Birla Carbon U.S.A., Inc., Marietta, GA (US)

(21) Appl. No.: 16/763,741

(22) PCT Filed: Nov. 13, 2018
(86) PCT No.: PCT/US2018/060724

§ 371 Date: May 13, 2020

Related U.S. Application Data
(60) Provisional application No. 62/585,178, filed on Nov. 13, 2017.

(51) Int. Cl. C08K 3/04

(52) U.S. Cl. CPC C08K 3/04; B60C 1/00

(57) ABSTRACT

A rubber composition containing an oxidized carbon black and exhibiting a significantly increased volume resistivity.

### BACKGROUND

### Technical Field

The present disclosure relates to rubber compositions comprising oxidized carbon blacks that exhibit a high volume resistivity, together with methods for the manufacture and use thereof.

### Technical Background

Rubber compositions are broadly used in various technological fields, and especially so in the automotive industry. Materials for automobiles continue to evolve and thus the need for innovative products has increased. The search for new materials has been motivated by the needs for improved fuel economy, reduced CO₂ emissions, changes in drivetrains (internal combustion engine versus electric), increased awareness for sustainability needs, and government regulations.

The implications for new materials means moving toward lighter weight, renewable resources and achieving a new paradigm in the balance of various rubber properties as may be important in any of the applications of rubber products. For instance, in automobile tires, improving all three properties such as wear, traction, and reduced hysteresis has proven quite difficult. As another example, and in particular, as related to automotive weatherstrip and other rubber goods, including hoses and anti-vibration components, higher resistivity is now a desired feature to limit corrosion and electrochemical degradation between the rubber components and the automobile body or engine components. Both phenomena can result in poor appearance and reduced lifetime of the automotive finish, body, and the rubber good itself

Currently, highly resistive rubber goods can be achieved by using large particle size and medium structure carbon blacks that maintain some level of stiffness and tensile strength, but also promote reduced conductivity or higher resistivity through reduced networking. Still, further increases in resistivity are required and the morphological approach has reached its limit, as drops in reinforcement and stiffness will be realized if carbon blacks with larger particle size and medium to lower structure are used to further increase the resistivity. Again another paradigm shift in the performance balance is required to achieve a highly resistive rubber compound while maintaining or improving other key properties.

Other approaches to increase resistivity involve reducing the amount of carbon black in the rubber goods and substituting other non-reinforcing fillers such as calcium carbonate, clays, or even precipitated silica. In all cases, the weight of the component can increase, which is not desirable, and the level of reinforcement may drop, and in the case of silica, may result in poorer processing and higher costs.

Thus, there is a need for the rubber compositions comprising carbon black that allow utilization of a wider range of carbon black morphology while significantly raising its resistivity level and thus significantly increasing the volume resistivity of the rubber compositions. Further, there is a need for the high volume resistivity rubber compositions having current or reduced levels of carbon black, and maintaining the current or lowering the weight of the rubber good without significant increases in cost. These needs, and other needs, are satisfied by the compositions and methods of the present disclosure.

### SUMMARY

In accordance with the purpose(s) of the invention, as embodied and broadly described herein, this disclosure, in one aspect, relates to a rubber composition comprising (a) an elastomer in an amount from about 50 to about 150 phr; and (b) an oxidized carbon black in an amount from about 50 to about 200 phr, wherein the oxidized carbon black comprises greater than 0% to about 4% of volatiles; and wherein the rubber composition has a volume resistivity from about 1×10² Ohm-cm to about 1×10¹³ Ohm-cm.

In still further aspects the rubber composition can comprise providing an elastomer blend.

In yet other aspects, the current disclosure relates to a method comprising: (a) providing an elastomer in an amount of 100 phr; (b) providing an oxidized carbon black in an amount from about 25 to about 250 phr, wherein the oxidized carbon black comprises greater than 0% to about 4% of volatiles; and (c) mixing the elastomer and the oxidized carbon black to form a rubber composition having a volume resistivity from about 1×10² Ohm-cm to about 1×10¹³ Ohm-cm.

In still further aspects the method can comprise providing an elastomer blend.

In still further aspects, the current disclosure relates to rubber compositions prepared accordingly to the disclosure methods. In yet other aspects, the current disclosure relates to various articles comprising the inventive rubber compositions.

Additional aspects of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE FIGURES

The accompanying figures, which are incorporated in and constitute a part of this specification, illustrate several aspects and together with the description serve to explain the principles of the invention.

FIG. 1 illustrates a plot of the different regimes of conductivity versus volume resistivity values.

FIG. 2 illustrates a shift in percolation behavior in one embodiment where the standard carbon black is compared to the oxidized carbon black.

FIG. 3 illustrates changes in the volume resistivity of the exemplary carbon black when it is oxidized.

FIG. 4A illustrates changes in the surface area as a function of a temperature for a thermally oxidized carbon black.

FIG. 4B illustrates changes in the amount of volatiles as a function of a temperature for a thermally oxidized carbon black.

### DESCRIPTION

The present invention can be understood more readily by reference to the following detailed description of the invention and the Examples included therein.

Before the present compounds, compositions, articles, systems, devices, and/or methods are disclosed and described, it is to be understood that they are not limited to specific synthetic methods unless otherwise specified, or to particular reagents unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

All publications mentioned herein are incorporated herein by reference to disclose and describe the methods and/or materials in connection with which the publications are cited.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, example methods and materials are now described. Test methods not specifically described herein reference conventional ASTM methods used in the carbon black industry. Unless cited to the contrary, the methods are intended to refer to the latest version currently employed at the time of this application in the carbon black industry, and to any options or preferences conventionally used.

### A. DEFINITIONS

It is also to be understood that the terminology used herein is for the purpose of describing particular aspects only and is not intended to be limiting. As used in the specification and in the claims, the term “comprising” may include the aspects “consisting of” and “consisting essentially of” Unless defined otherwise, all technical and scientific terms used herein have the same meaning as commonly understood by one of ordinary skill in the art to which this invention belongs. In this specification and in the claims which follow, reference will be made to a number of terms which shall be defined herein.

As used herein, unless specifically stated to the contrary, the singular forms “a,” “an” and “the” include plural referents unless the context clearly dictates otherwise. Thus, for example, reference to “an elastomer” or “a filler” includes mixtures of two or more elastomers, or fillers, respectively.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “optional” or “optionally” means that the subsequently described event or circumstance can or cannot occur, and that the description includes instances where said event or circumstance occurs and instances where it does not.

As used herein, the term “combination” is inclusive of blends, reactive mixtures, mixtures, alloys, reaction products, and the like.

As used herein, unless specifically stated to the contrary, the abbreviation “phr” is intended to refer to parts per hundred, as is typically used in the rubber industry to describe the relative amount of each ingredient in a composition.

A weight percent (“wt %”) of a component, unless specifically stated to the contrary, is based on the total weight of the formulation or composition in which the component is included. For example if a particular element or component in a composition or article is said to have 8% by weight, it is understood that this percentage is relative to a total compositional percentage of 100% by weight.

As used herein, the term “substantially,” in, for example, the context “substantially free” refers to a composition having less than about 1% by weight, e.g., less than about 0.5% by weight, less than about 0.1% by weight, less than about 0.05% by weight, or less than about 0.01% by weight of the stated material, based on the total weight of the composition.

It is further understood that the terms “substantially similar” or “substantially identical” can be used interchangeably, and when used in reference to a composition, refer to at least about 60% by weight, e.g., at least about 65%, at least about 70%, at least about 75%, at least about 80%, at least about 85%, at least about 90%, at least about 91%, at least about 92%, at least about 93%, at least about 94%, at least about 95%, at least about 96%, at least about 97%, at least about 98%, at least about 99%, or about 100% by weight, based on the total weight of the composition, of a specified feature or component. When the term is used in reference to a specific property or a characteristic of the composition or the formulation, these terms mean that the property or the characteristic of the compositions or the formulations being compared does not differ by more than 0.5%, 1%, 2%, 5%, 10%, 15%, 20%, 25%, 30%, 35%, 40%, 45%, 50%, 55% or 60%. Alternatively, these terms mean that the property or the characteristic of the compositions or the formulations being compared does not differ by more than, for example, 0.5%, 1%, 2%, 5%, 10%, 15%, 20%, 25% or 30%. Alternatively, these terms mean that the property or the characteristic of the compositions or the formulations being compared does not differ by more than, for example, 0.5%, 1%, 2%, 5%, 10%, or 15%.

As used herein, the term “substantially identical reference composition” refers to a composition produced by the substantially identical methods to the inventive composition by providing essentially or substantially the same proportions and components but in the absence of a stated component. For example and without limitation, in some aspects of the invention, for purposes of comparison to a corresponding reference composition, as used herein, corresponding reference composition is formed essentially by the same method steps as the inventive composition but for the absence of oxidized carbon black. Even more specifically, as referenced herein the substantially identical reference composition is formed essentially by the same method steps as the inventive composition and having essentially the same proportions of the components with the difference that the carbon black present in the substantially identical reference composition is not oxidized. In such reference compositions, the non-oxidized carbon black has a substantially identical surface area as measured by NSA or STSA and has substantially identical structure or OAN and COAN values. In still other aspects, the “substantially identical reference composition” as used herein employs the same type of carbon black as used for inventive composition prior to oxidation.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific embodiment or combination of embodiments of the methods of the invention.

It is further understood that the term “volatile” as used herein, refers to an amount of oxidized species evolved from the carbon black surface at 950° C.

Each of the materials disclosed herein are either commercially available and/or the methods for the production thereof are known to those of skill in the art.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

### B. RUBBER COMPOSITIONS

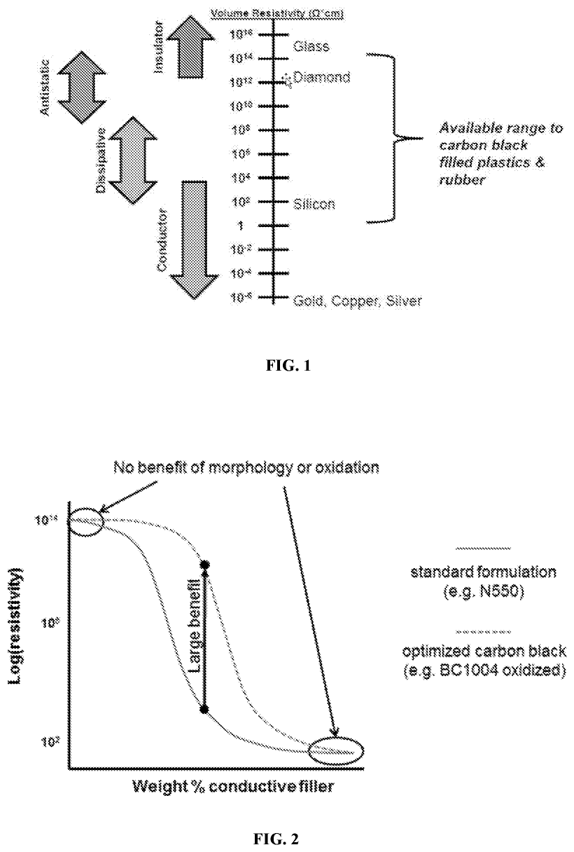

As one of ordinary skill in the art would readily appreciate, carbon black itself is conductive, and in a rubber compound, once the loading is high enough to reach the percolation threshold at which point a carbon black network is formed, the rubber compound becomes conductive. This change in conductivity from non-conductive to conductive can be fairly sharp and can depend upon the carbon black particle size and structure, with larger particle size and lower structure generally yielding more highly resistive rubber compounds and higher loadings of carbon black to reach the percolation threshold. Again however, the limit in larger particle size has been reached and new approaches are required. Another complicating factor is that many sealing systems, such as automobile weatherstrip or profile compounds, use high loadings of carbon black and oil to reduce costs, but the high loadings lead to a well-developed carbon black network with low resistivity (high conductivity). Thus, to be able to maintain high carbon black loadings at significantly higher resistivity, the surface of the carbon black can be functionalized with oxygen functional groups, which by their high level of electronegativity, can significantly increase the resistivity of the carbon black and its network, even at high loadings as might be used in automotive sealing systems. FIG. 1 illustrates the different regimes of conductivity versus volume resistivity values as a reference to allow an understanding of the increase in resistivity that can be achieved through surface modification of the carbon black.

In some aspects described herein is a rubber composition comprising (a) an elastomer in an amount from about 50 to about 150 phr; and (b) an oxidized carbon black in an amount from about 25 to about 250 phr, wherein the oxidized carbon black comprises greater than 0% to about 4% of volatiles; and wherein the rubber composition has a volume resistivity from about 1×10² Ohm-cm to about 1×10¹³ Ohm-cm. In still further aspects the rubber composition can comprise providing an elastomer blend.

It is understood that the elastomer used in the aspects of present disclosure can be any elastomer known in the art. In certain aspects, the elastomer comprises at least one of natural rubber, nitrile rubber, neoprene, styrene-butadiene rubber (SBR), ethylene propylene diene monomer rubber (EPDM), or any combination thereof. In still further aspects, the elastomer can comprise solution styrene-butadiene rubber (solution-SBR). In yet still other aspects, the elastomer can comprise ethylene propylene diene monomer rubber (EPDM).

In certain aspects, the elastomer or elastomer blend is present in an amount of about 100 phr. In other aspects, an individual elastomer component can be present in any given amount up to and including the total elastomer amount.

In yet other aspects, the elastomer is present in an amount greater than 0 wt % to less than about 100 wt %, including exemplary values of about 1 wt %, about 2 wt %, about 3 wt %, about 4 wt %, about 5 wt %, about 10 wt %, about 15 wt %, about 20 wt %, about 25 wt , about 30 wt %, about 35 wt %, about 40 wt %, about 45 wt %, about 50 wt %, about 55 wt %, about 60 wt %, about 65 wt %, about 70 wt %, about 75 wt %, about 80 wt %, about 85 wt %, about 90 wt %, and about 95 wt%. In still further aspects, the elastomer is present in an amount of about 15 wt % to about 90 wt % including exemplary values of about 15 wt %, 20 wt %, about 25 wt %, about 30 wt %, about 35 wt %, about 40 wt %, about 45 wt %, about 50 wt %, about 55 wt %, about 60 wt %, about 65 wt %, about 70 wt %, about 75 wt %, about 80 wt %, 85 wt %, and about 90 wt %. It is further understood that the elastomer can be present in any amount between any two foregoing values.

In some aspects, the oxidized carbon black is present in an amount 25 to about 250 phr, including exemplary values of about 30 phr, about 40 phr, about 50 phr, 60 phr, about 70 phr, about 80 phr, about 90 phr, about 100 phr, about 110 phr, about 120 phr, about 130 phr, about 140 phr, about 150 phr, about 160 phr, about 170 phr, about 180 phr, about 190 phr, about 200 phr, about 210 phr, about 220 phr, about 230 phr, and about 240 phr. It is further understood that the oxidized carbon black can be present in any amount between any two foregoing values.

In yet other aspects, the oxidized carbon black is present in an amount greater than 0 wt % to less than about 100 wt %, including exemplary values of about 1 wt %, about 2 wt %, about 3 wt %, about 4 wt %, about 5 wt %, about 10 wt %, about 15 wt %, about 20 wt %, about 25 wt %, about 30 wt %, about 35 wt %, about 40 wt %, about 45 wt %, about 50 wt %, about 55 wt %, about 60 wt %, about 65 wt %, about 70 wt %, about 75 wt %, about 80 wt %, about 85 wt %, about 90 wt %, and about 95 wt%. In still further aspects, the oxidized carbon black is present in the composition in an amount from about 10 wt % to about 50 wt %. It is further understood that the oxidized carbon black can be present in any amount between any two foregoing values.

It is further understood that in various aspects, any known carbon black can be selected to be oxidized. In certain aspects, carbon black selected to be oxidized and used in the present invention can comprise acetylene black, channel black, furnace black, lamp black and/or thermal black.

It should be noted that the carbon black of the present disclosure can comprise any carbon black or a blend of carbon blacks. In one aspect, the carbon black can comprise a furnace carbon black. In another aspect, the carbon black can have a colloidal balance described by ASTM grade carbon blacks, such as, for example, N134, N121, N115, N110, N220, N234, N299, N330, N339, N550, N539, N660, N762, N772, or N990, and in another aspect the carbon blacks of the present invention can comprise carbon blacks of non-ASTM colloidal balance and range in surface area, whether it be Iodine number (ASTM D1510), Nitrogen Surface Area (ASTM D6556) or Statistical Thickness Surface Area, STSA (ASTM D6556) from 10 to 500 m²/g and bulk structure levels as described by the Oil Absorption Number OAN (ASTM D2414) from 10 to 300 cc/100 g or the Compressed Oil Absorption Number, COAN (ASTM D3493) from 10 to 300 m²/g.

In still further aspects, the carbon blacks of the present disclosure can have NSA values from about 10 to about 500 m²/g, including exemplary values of about 20 m²/g, about 30 m²/g, about 40 m²/g, about 50 m²/g, about 60 m²/g, about 70 m²/g, about 80 m²/g, about 90 m²/g, about 100 m²/g, about 110 m²/g, about 120 m²/g, about 130 m²/g, about 140 m²/g, about 150 m²/g, about 160 m²/g, about 170 m²/g, about 180 m²/g, about 190 m²/g, about 200 m²/g, about 210 m²/g, about 220 m²/g, about 230 m²/g, about 240 m²/g, about 250 m²/g, 260 m²/g, about 270 m²/g, about 280 m²/g, about 290 m²/g, about 300 m²/g, about 310 m²/g, about 320 m²/g, about 330 m²/g, about 340 m²/g, about 350 m²/g, about 360 m²/g, about 370 m²/g, about 380 m²/g, about 390 m²/g, about 400 m²/g, about 410 m²/g, about 420 m²/g, about 430 m²/g, about 440 m²/g, about 450 m²/g, 460 m²/g, about 470 m²/g, about 480 m²/g, and about 490 m²/g. It is understood that the carbon black selected for use in the present disclosure can have any NSA value between any two foregoing values. In some aspects, carbon black can have NSA values from about 10 to about 300 m²/g, from about 40 to about 300 m²/g, from about 20 to about 100 m²/g, or from about 40 to about 200 m²/g.

In still further aspects, the carbon blacks of the present disclosure can have STSA values from about 10 to about 500 m²/g, including exemplary values of about 20 m²/g, about 30 m²/g, about 40 m²/g, about 50 m²/g, about 60 m²/g, about 70 m²/g, about 80 m²/g, about 90 m²/g, about 100 m²/g, about 110 m²/g, about 120 m²/g, about 130 m²/g, about 140 m²/g, about 150 m²/g, about 160 m²/g, about 170 m²/g, about 180 m²/g, about 190 m²/g, about 200 m²/g, about 210 m²/g, about 220 m²/g, about 230 m²/g, about 240 m²/g, about 250 m²/g, 260 m²/g, about 270 m²/g, about 280 m²/g, about 290 m²/g, about 300 m²/g, about 310 m²/g, about 320 m²/g, about 330 m²/g, about 340 m²/g, about 350 m²/g, about 360 m²/g, about 370 m²/g, about 380 m²/g, about 390 m²/g, about 400 m²/g, about 410 m²/g, about 420 m²/g, about 430 m²/g, about 440 m²/g, about 450 m²/g, 460 m²/g, about 470 m²/g, about 480 m²/g, and about 490 m²/g. It is understood that the carbon black selected for use in the present disclosure can have any STSA value between any two foregoing values. In some aspects, carbon black can have STSA values from about 10 to about 300 m²/g, from about 40 to about 300 m²/g, from about 20 to about 100 m²/g, or from about 40 to about 200 m²/g.

In still further aspects, the carbon blacks of the present disclosure can have any OAN values from about 10 to about 300 cc/100 g, or from about 40 to about 300 cc/100 g, including exemplary values of about 20 cc/100 g, about 30 cc/100 g, about 40 cc/100 g, about 50 cc/100 g, about 60 cc/100 g, about 70 cc/100 g, about 80 cc/100 g, about 90 cc/100 g, about 100 cc/100 g, about 110 cc/100 g, about 120 cc/100 g, about 130 cc/100 g, about 140 cc/100 g, about 150 cc/100 g, about 160 cc/100 g, about 170 cc/100 g, about 180 cc/100 g, about 190 cc/100 g, about 200 cc/100 g, about 210 cc/100 g, about 220 cc/100 g, about 230 cc/100 g, about 240 cc/100 g, about 250 cc/100 g, 260 cc/100 g, about 270 cc/100 g, about 280 cc/100 g, and about 290 cc/100 g. It is understood that carbon black selected for use in the present disclosure can have any OAN value between any two foregoing values. In some aspects, the oxidized carbon black can have OAN values from about 30 to about 300 cc/100 g, from about 50 to about 300 cc/100 g, from about 80 to about 200 cc/100 g, or from about 100 to about 300 cc/100 g.

In still further aspects, the carbon blacks of the present disclosure can have any COAN values from about 10 to about 300 cc/100 g, or from about 40 cc/100 g, including exemplary values of about 20 cc/100 g, about 30 cc/100 g, about 40 cc/100 g, about 50 cc/100 g, about 60 cc/100 g, about 70 cc/100 g, about 80 cc/100 g, about 90 cc/100 g, about 100 cc/100 g, about 110 cc/100 g, about 120 cc/100 g, about 130 cc/100 g, about 140 cc/100 g, about 150 cc/100 g, about 160 cc/100 g, about 170 cc/100 g, about 180 cc/100 g, about 190 cc/100 g, about 200 cc/100 g, about 210 cc/100 g, about 220 cc/100 g, about 230 cc/100 g, about 240 cc/100 g, about 250 cc/100 g, 260 cc/100 g, about 270 cc/100 g, about 280 cc/100 g, and about 290 cc/100 g. It is understood that the carbon black selected for use in the present disclosure can have any COAN value between any two foregoing values. In some aspects, carbon black can have COAN values from about 30 to about 300 cc/100 g, from about 50 to about 300 cc/100 g, from about 80 to about 200 cc/100 g, or from about 100 to about 300 cc/100 g.

To oxidize carbon black, various known in the art methods can be utilized. In certain aspects, the oxidized carbon black is obtained by ozone oxidation, thermal oxidation, peroxide oxidation, acid oxidation, for example with nitric acid, and/or any combination thereof or other treatments can be employed. In certain aspects, the oxidized carbon black is obtained by ozone oxidation. In yet other aspects, the oxidized carbon black is obtained by peroxide oxidation. In still further aspects, the oxidized carbon black is obtained by acid oxidation. In still further aspects, the oxidized carbon black is obtained by thermal oxidation. In yet other aspects, the oxidized carbon black is not thermally oxidized carbon black. In still further aspects, the oxidized carbon black is not obtained by a thermal oxidation.

Such treatments can be performed in-situ during a portion of the manufacturing process or as a post-treatment process, for example, either in a batch or continuous process. In one aspect, a treatment, such as, for example, ozone treatment, can be performed in a rotating drum or in a fluidized bed as a post-treatment process.

Carbon blacks can be functionalized with many different chemical moieties, ranging from adsorbed molecules, oligomer grafts, and specific functional groups that are covalently bonded. This functionalization is generally believed to occur on the edge sites of graphene planes at the surface of the carbon black.

For various applications, it has become important to improve the surface functionality of carbon black with increased surface group concentrations and more uniform surface chemistry, as much as can be realistically obtained. It should also be understood that completely covering the surface of carbon black particles with functional groups may not be necessary and may make the resulting carbon black too reactive and requiring significant energy and highly intensive treatments to add higher and higher levels of functional groups. While not wishing to be bound by theory, it is now believed that an ideal balance is to functionalize each available graphene layer edge site capable of being functionalized.

In still further aspects, the oxidized carbon black used in the present disclosure can have NSA values from about 10 to about 500 m²/g, including exemplary values of about 20 m²/g, about 30 m²/g, about 40 m²/g, about 50 m²/g, about 60 m²/g, about 70 m²/g, about 80 m²/g, about 90 m²/g, about 100 m²/g, about 110 m²/g, about 120 m²/g, about 130 m²/g, about 140 m²/g, about 150 m²/g, about 160 m²/g, about 170 m²/g, about 180 m²/g, about 190 m²/g, about 200 m²/g, about 210 m²/g, about 220 m²/g, about 230 m²/g, about 240 m²/g, about 250 m²/g, 260 m²/g, about 270 m²/g, about 280 m²/g, about 290 m²/g, about 300 m²/g, about 310 m²/g, about 320 m²/g, about 330 m²/g, about 340 m²/g, about 350 m²/g, about 360 m²/g, about 370 m²/g, about 380 m²/g, about 390 m²/g, about 400 m²/g, about 410 m²/g, about 420 m²/g, about 430 m²/g, about 440 m²/g, about 450 m²/g, 460 m²/g, about 470 m²/g, about 480 m²/g, and about 490 m²/g. It is understood that the oxidized carbon black selected for use in the present disclosure can have any NSA value between any two foregoing values. In some aspects, the oxidized carbon black can have NSA values from about 10 to about 300 m²/g, from about 40 to about 300 m²/g, from about 20 to about 100 m²/g, or from about 40 to about 200 m²/g.

In still further aspects, the oxidized carbon blacks of the present disclosure can have STSA values from about 10 to about 500 m²/g, including exemplary values of about 20 m²/g, about 30 m²/g, about 40 m²/g, about 50 m²/g, about 60 m²/g, about 70 m²/g, about 80 m²/g, about 90 m²/g, about 100 m²/g, about 110 m²/g, about 120 m²/g, about 130 m²/g, about 140 m²/g, about 150 m²/g, about 160 m²/g, about 170 m²/g, about 180 m²/g, about 190 m²/g, about 200 m²/g, about 210 m²/g, about 220 m²/g, about 230 m²/g, about 240 m²/g, about 250 m²/g, 260 m²/g, about 270 m²/g, about 280 m²/g, about 290 m²/g, about 300 m²/g, about 310 m²/g, about 320 m²/g, about 330 m²/g, about 340 m²/g, about 350 m²/g, about 360 m²/g, about 370 m²/g, about 380 m²/g, about 390 m²/g, about 400 m²/g, about 410 m²/g, about 420 m²/g, about 430 m²/g, about 440 m²/g, about 450 m²/g, 460 m²/g, about 470 m²/g, about 480 m²/g, and about 490 m²/g. It is understood that the oxidized carbon black selected for use in the present disclosure can have any STSA value between any two foregoing values. In some aspects, the oxidized carbon black can have STSA values from about 10 to about 300 m²/g, from about 40 to about 300 m²/g, from about 20 to about 100 m²/g, or from about 40 to about 200 m²/g.

In still further aspects, the starting materials for the oxidized carbon blacks (i.e., the carbon blacks prior to oxidation) of the present disclosure can have any OAN values from about 10 to about 300 cc/100 g, or from about 40 cc/100 g, including exemplary values of about 20 cc/100 g, about 30 cc/100 g, about 40 cc/100 g, about 50 cc/100 g, about 60 cc/100 g, about 70 cc/100 g, about 80 cc/100 g, about 90 cc/100 g, about 100 cc/100 g, about 110 cc/100 g, about 120 cc/100 g, about 130 cc/100 g, about 140 cc/100 g, about 150 cc/100 g, about 160 cc/100 g, about 170 cc/100 g, about 180 cc/100 g, about 190 cc/100 g, about 200 cc/100 g, about 210 cc/100 g, about 220 cc/100 g, about 230 cc/100 g, about 240 cc/100 g, about 250 cc/100 g, 260 cc/100 g, about 270 cc/100 g, about 280 cc/100 g, and about 290 cc/100 g. It is understood that the oxidized carbon black selected for use in the present disclosure can have any OAN value between any two foregoing values. In some aspects, the oxidized carbon black can have OAN values from about 30 to about 300 cc/100 g, from about 50 to about 300 cc/100 g, from about 80 to about 200 cc/100 g, or from about 100 to about 300 cc/100 g.

In still further aspects, the starting materials for the oxidized carbon blacks of the present disclosure can have any COAN values from about 10 to about 300 cc/100 g, or from about 40 to about 300 cc/100 g, including exemplary values of about 20 cc/100 g, about 30 cc/100 g, about 40 cc/100 g, about 50 cc/100 g, about 60 cc/100 g, about 70 cc/100 g, about 80 cc/100 g, about 90 cc/100 g, about 100 cc/100 g, about 110 cc/100 g, about 120 cc/100 g, about 130 cc/100 g, about 140 cc/100 g, about 150 cc/100 g, about 160 cc/100 g, about 170 cc/100 g, about 180 cc/100 g, about 190 cc/100 g, about 200 cc/100 g, about 210 cc/100 g, about 220 cc/100 g, about 230 cc/100 g, about 240 cc/100 g, about 250 cc/100 g, 260 cc/100 g, about 270 cc/100 g, about 280 cc/100 g, and about 290 cc/100 g. It is understood that the oxidized carbon black selected for use in the present disclosure can have any COAN value between any two foregoing values. In some aspects, the oxidized carbon black can have COAN values from about 50 to about 300 cc/100 g, from about 50 to about 300 cc/100 g, from about 80 to about 200 cc/100 g, or from about 100 to about 300 cc/100 g.

For commercially useful oxidized carbon blacks, the level of oxidation needs to be controlled. In some aspects, the oxidized carbon blacks used in this disclosure do not have increased porosity, as defined herein as the difference between the NSA and STSA. In certain aspects, the oxidized carbon black comprises from greater than 0% to about 4% of volatiles, including exemplary values of about 0.1%, 0.2%, 0.3%, 0.4%, 0.5%, 0.6%, 0.7%, 0.8%, 0.9%, 1%, 1.1%, 1.2%, 1.3%, 1.4%, 1.5%, 1.6%, 1.7%, 1.8%, 1.9%, 2%, 2.1%, 2.2%, 2.3%, 2.4%, 2.5%, 2.6%, 2.7%, 2.8%, 2.9%, 3%, 3.1%, 3.2%, 3.3%, 3.4%, 3.5%, 3.6%, 3.7%, 3.8%, and about 3.9%. It is understood that volatiles can be present in any amount between any two foregoing values. In some aspects, the oxidized carbon black comprises from about 0.5% to about 3.5%, or from about 0.2% to about 2.5%, or from about 1% to about 3.7%.

In other aspects, it is understood that the oxidation process selected to obtain the oxidized carbon black is such that all or a portion of the surface can be functionalized without adding any or any significant level of porosity. In still further aspects, the oxidized carbon black used in this disclosure exhibits a substantially identical porosity as compared to a non-oxidized carbon black having a substantially identical NSA, STSA, OAN, and/or COAN values.

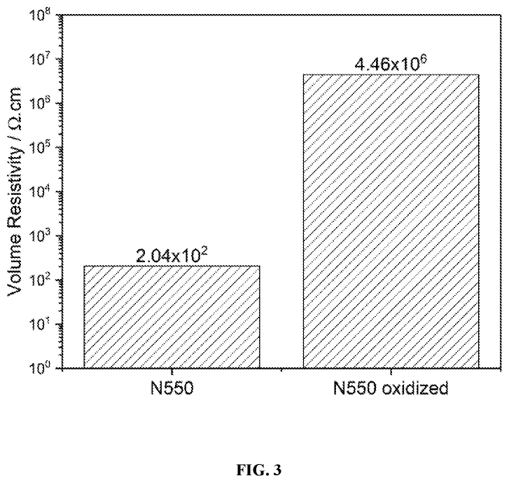

As discussed in detail above, the region around percolation threshold is important as it defines the maximum carbon black loading one can afford without a significant change in the resistivity of the rubber composition. FIG. 2 illustrates a shift in percolation behavior in one embodiment where the standard carbon black is compared to the oxidized carbon black. In some aspects of the present disclosure the percolation region of carbon black as measured prior to an oxidation is shifted by greater than 0 to about 100% after the carbon black is oxidized. In yet other aspects such shift is from about 1 to about 99%, including exemplary values of about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, and about 98%. As one of ordinary skill in the art would readily appreciate such shift indicates that a much larger amount of the oxidized carbon black can be added to the rubber composition without negatively affecting the volume resistivity of the rubber composition.

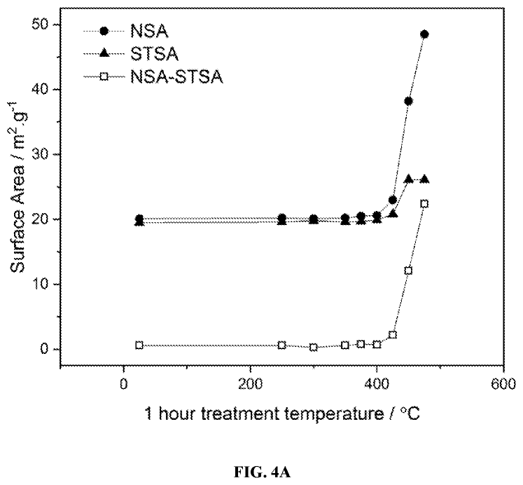

It is understood that in some aspects, the change in the volumetric resistivity of the rubber compositions is due to the change in the volumetric resistivity of the oxidized carbon black. For example, FIG. 3 shows changes in the volume resistivity of regular N550 carbon black versus an oxidized N550. In this exemplary aspect, a significant change of at least four orders of magnitude in the volumetric resistivity of the carbon black is achieved through surface modification.

In some other aspects, the rubber composition described herein can further comprise a vulcanization accelerator. As one of ordinary skill in the art would readily appreciate use of accelerators and activators are common in the rubber industry. The vulcanization process is generally used to convert polymers into more durable materials by introducing cross-links between polymer chains. In some aspects, organic polymers can be crosslinked by insertion, for example, of sulfidic linkages between chains. Vulcanization accelerators are used to break open elemental sulfur rings (S₈) in the initial stages of the vulcanization reaction. There are many accelerators available for the vulcanization of rubber.

As one of ordinary skill in the art would appreciate, the specific type of the vulcanization accelerator can depend on a type of rubber and/or specific application. In certain aspects, vulcanization accelerator can be used in combination with sulfur as the cross-linker, and/or with zinc oxide and stearic acid as activators.

In some aspects, the vulcanization accelerators can comprise sulfonamides, thiazoles, ethylene thiourea (ETU), thiurams, dithiocarbamates. In yet other aspects, the vulcanization accelerators can comprise mercaptobenzthiazole (MBT), mercaptobenzthiazole disulfide (MBTS), tetramethylthiuram disulfide (TMTD), tetraethylthiuram disulfide (TETD), zinc diethyldithiocarbamate (ZDEC), zinc dibutyldithiocarbamate (ZDBC), or any combination thereof.

In still further aspects, the vulcanization accelerator is present in the composition in an amount from about 0.1 to about 6.0 phr, including exemplary values of about 0.2 phr, about 0.3 phr, about 0.4 phr, about 0.5 phr, about 0.6 phr, about 0.7 phr, about 0.8 phr, about 0.9 phr, about 1 phr, about 1.1 phr, about 1.2 phr, about 1.3 phr, about 1.4 phr, about 1.5 phr, about 1.6 phr, about 1.7 phr, about 1.8 phr, about 1.9 phr, about 2.0 phr, about 2.2 phr, 2.5 phr, about 2.8 phr, about 3.0 phr, about 3.2 phr, about 3.5 phr, about 3.8 phr, about 4.0 phr, about 4.2 phr, about 4.5 phr, about 4.8 phr, about 5.0 phr, about 5.2 phr, about 5.5 phr, and about 5.8 phr. In still further aspects, the vulcanization accelerator can be present in any amount between any two foregoing values. In yet still further aspects, the vulcanization accelerator is present in an amount from about 0.2 to about 1.8 phr, or from about 0.5 to about 1.5 phr, or from about 0.1 to about 5 phr.

It is understood that the rubber composition as described has a volume resistivity from about 1×10² Ohm-cm to about lx10¹³ Ohm-cm. In some aspects, the disclosed rubber composition has a volume resistivity of about 1×10² Ohm-cm, about 1×10³ Ohm-cm, about 1×10⁴ Ohm-cm, about 1×10⁵ Ohm-cm, about 1×10⁶ Ohm-cm, about 1×10⁷ Ohm-cm, about 1×10⁸ Ohm-cm, about 1×10⁹ Ohm-cm, about 1×10¹⁰ Ohm-cm, about 1×10¹¹ Ohm-cm, about 1×10¹² Ohm-cm, or about 1×10¹³ Ohm-cm. It is understood that a volume resistivity of the disclosed rubber can have any value between any two foregoing values.

In still further aspects, the rubber composition exhibits an increase in a volumetric resistivity of at least one order of magnitude when compared to a substantially identical reference composition. As described above, the substantially identical reference composition is the composition produced by the substantially identical methods to the inventive composition by providing essentially or substantially the same proportions and components but in the absence of a stated component. Even more specifically, as referenced herein the substantially identical reference composition is formed essentially by the same method steps as the inventive composition and having essentially the same proportions of the components with the difference that the carbon black present in the substantially identical reference composition is not oxidized. In such reference compositions, the non-oxidized carbon black has a substantially identical surface area as measured by NSA or STSA and has a substantially identical OAN and COAN values.

In still other aspects, the “substantially identical reference composition” as used herein employs the same type of carbon black as used for inventive composition prior to oxidation. In still further aspects, the disclosed rubber composition exhibits an increase in a volumetric resistivity of at least two orders of magnitude when compared to a substantially identical reference composition. In yet other aspects, the disclosed rubber composition exhibits an increase in a volumetric resistivity of at least three orders of magnitude when compared to a substantially identical reference composition. In still further aspects, the disclosed rubber composition exhibits an increase in a volumetric resistivity of at least four orders of magnitude when compared to a substantially identical reference composition. In yet other aspects, the rubber composition exhibits an increase in a volumetric resistivity of at least five orders of magnitude when compared to a substantially identical reference composition. In still further aspects, the rubber composition exhibits an increase in a volumetric resistivity of at least six orders of magnitude when compared to a substantially identical reference composition. In still further aspects, the rubber composition exhibits an increase in a volumetric resistivity of at least seven orders of magnitude when compared to a substantially identical reference composition. In still further aspects, the rubber composition exhibits an increase in a volumetric resistivity of at least eight orders of magnitude when compared to a substantially identical reference composition. In still further aspects, the rubber composition exhibits an increase in a volumetric resistivity of at least nine orders of magnitude when compared to a substantially identical reference composition. In still further aspects, the rubber composition exhibits an increase in a volumetric resistivity of at least ten orders of magnitude when compared to a substantially identical reference composition.

It is understood that the inventive rubber compositions have superior electrical properties, the mechanical properties of the inventive compositions are substantially identical or improved when compared to a substantially identical reference rubber compositions.

For example and without limitations, a rubber stiffness measured at 100% to 300% tensile stress of the inventive compositions is substantially identical to a stiffness measured at similar conditions of the substantially identical reference rubber composition. In certain aspects, a rubber modulus measured at 100% to 300% tensile strain of the inventive compositions differs less than about 1%, less than about 2%, less than about 3%, less than about 5%, less than about 10%, less than about 15%, less than about 20%, less than about 25%, less than about 30%, less than about 35%, or less than about 40%, from a modulus measured at 100% to 300% tensile strain measured for a substantial identical reference composition. In still further aspects, a rubber modulus measured at 100% to 300% tensile strain of the inventive compositions differs not greater than about 40%, not greater than about 35%, not greater than about 30%, not greater than about 25%, not greater than about 20%, not greater than about 15%, not greater than about 10%, not greater than about 5%, not greater than about 3%, not greater than about 2%, or not greater than about 1% from a modulus measured at 100% to 300% tensile strain measured for a substantially identical reference composition.

In still further aspects, the rubber composition exhibits substantially identical elongation as compared to a substantially identical reference rubber composition. In yet other aspects, elongation of the inventive compositions differs less than about 1%, less than about 2%, less than about 3%, less than about 5%, less than about 10%, less than about 15%, less than about 20%, less than about 25%, less than about 30%, less than about 35%, or less than about 40% from elongation measured for a substantial identical reference composition. In still further aspects, elongation of the inventive compositions differs not greater than about 40%, not greater than about 35%, not greater than about 30%, not greater than about 25%, not greater than about 20%, not greater than about 15%, not greater than about 10%, not greater than about 5%, not greater than about 3%, not greater than about 2%, or not greater than about 1% from elongation measured for a substantial identical reference composition.

In still further aspects, the rubber composition exhibits a substantially identical Mooney viscosity value when compared to a substantially identical reference rubber composition. In yet other aspects, a Mooney viscosity value of the inventive compositions differs less than about 2%, less than about 3%, less than about 5%, less than about 10%, less than about 15%, less than about 20%, less than about 25%, less than about 30%, less than about 35%, or less than about 40%, from a Mooney viscosity value measured for a substantial identical reference composition. In still further aspects, a Mooney viscosity value of the inventive compositions differs not greater than about 40%, not greater than about 35%, not greater than about 30%, not greater than about 25%, not greater than about 20%, not greater than about 15%, not greater than about 10%, not greater than about 5%, not greater than about 3%, or not greater than about 2%, from a Mooney viscosity value measured for a substantial identical reference composition.

In still further aspects, the rubber composition exhibits a substantially identical Shore A hardness value when compared to a substantially identical reference rubber composition. In yet other aspects, a Shore A hardness value of the inventive compositions differs less than about 2%, less than about 3%, less than about 5%, less than about 10%, less than about 15%, less than about 20%, less than about 25%, less than about 30%, less than about 35%, or less than about 40%, from a shore a hardness value measured for a substantial identical reference composition. In still further aspects, a Shore A hardness value of the inventive compositions differs not greater than about 40%, not greater than about 35%, not greater than about 30%, not greater than about 25%, not greater than about 20%, not greater than about 15%, not greater than about 10%, not greater than about 5%, not greater than about 3%, or not greater than about 2%, from a Shore A hardness value measured for a substantial identical reference composition.

In certain aspects, disclosed herein are also articles prepared from the disclosed rubber compositions. As one of ordinary skill in the art would readily appreciate any suitable articles can be made using the inventive rubber compositions. In some aspects, the articles comprise a hose, an anti-vibration component, an automotive sealing system including weatherstrip and profile components, a tire, or any combination thereof.

### C. METHODS

In certain aspects described herein is a method of making the disclosed above rubber compositions. In some aspects, disclosed herein a method comprising: (a) providing an elastomer in an amount of about 100 phr; (b) providing an oxidized carbon black in an amount from about 25 to about 250 phr, wherein the oxidized carbon black comprises greater than 0% to about 4% of volatiles; and (c) mixing the elastomer and the oxidized carbon black to form a rubber composition having a volume resistivity from about 1×10² Ohm-cm to about 1×10¹³ Ohm-cm. In yet other aspects, the method comprises the step of providing an elastomer blend.

It is understood that the elastomers utilized in the disclosed method can comprise any elastomer described above. It is further understood that these elastomers can be present in any amounts as described herein to provide for the rubber composition exhibiting the disclosed properties. Similarly any oxidized carbon blacks described herein can be used in any disclosed amounts to prepare the rubber composition exhibiting the disclosed properties.

It is further understood that any types of mixing can be utilized to prepare the inventive rubber composition. In certain aspects, the step of mixing comprises a reactive mixing. In yet other aspects, the step of mixing comprises a conventional step of mixing of ingredients. In still further aspects, the step of mixing comprises blending. In certain aspects, the step of mixing results in homogeneous compositions.

In certain aspects, the methods described herein also comprises a step of providing about 0.1 to about 6 phr of a vulcanization accelerator prior to the step of mixing. It is understood that any vulcanization accelerator described herein can be utilized. In still further aspects, the vulcanization accelerator can be present in any amount as described above.

As disclosed above the oxidized carbon blacks used in the methods of the current disclosure can be obtained by ozone oxidation, a peroxide oxidation, a thermal oxidation, an acid oxidation or any combination thereof. In still further aspects, the oxidized carbon blacks can be obtained by ozone oxidation. In yet other aspects, the oxidized carbon blacks can be obtained by peroxide oxidation. In still further aspects, the oxidized carbon blacks can be obtained by acid oxidation, for example and without limitation, by reaction with nitric acid. In still further aspects, the oxidized carbon black can be obtained by thermal oxidation. In still further aspects, the oxidized carbon black is obtained by methods other than thermal oxidation. In still further aspects, the oxidized carbon black is not thermally oxidized.

It is understood that the rubber compositions obtained by the methods of the current invention exhibits all above disclosed properties. In still further aspects, described herein are articles that can be prepared from the rubber composition made by the inventive methods.

The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

### D. EXAMPLES

The following examples are put forth so as to provide those of ordinary skill in the art with a complete disclosure and description of how the compounds, compositions, articles, devices and/or methods claimed herein are made and evaluated, and are intended to be purely exemplary and are not intended to limit the disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### Example 1

To determine the effect of various oxidation levels, three different rubber compositions were prepared according to the proportions shown in Table 1. The EPDM elastomer was used to prepare the rubber composition. Carbon black, type, N550, having an NSA about 40 m²/g and OAN about 121 cc/100 g was used to form the compositions. Two carbon blacks were ozone oxidized. The oxidation content was measured for two ozone oxidized carbon blacks and one carbon black that was not oxidized but exhibits a small amount of nascent violate content. The results are shown in Table 2. The volumetric resistivity of the resulting rubber composition was measured using 4 point probes and the results are also shown in Table 2.

TABLE 1
Rubber composition
EPDM Formulation

| Component | PHR |
|---|---|
| Vistalon 7500 | 100.0 |
| Carbon black | 100.0 |
| Sunpar 2280 | 85.0 |
| Zinc Oxide (Kadox 930C) | 4.0 |
| Stearic Acid | 1.5 |
| Altax/MBTS | 1.3 |
| Methyl Tuads (TMTD) | 0.8 |
| ZDBC (butyl zimate) | 0.8 |
| Sulfur (RM-90) | 1.8 |
| Total | 295.2 |
| Carbon Black, wt % | 32 |

TABLE 2
The Volume Resistivity of the Rubber Composition

| Sample | Volatile, % | Volumetric Resistivity, Ω · cm |
|---|---|---|
| Sample 1 | 1% (nascent) | 2.0 × 10² |
| Sample 2 | 2.3% | 6.3 × 10⁴ |
| Sample 3 | 2.6% | 4.6 × 10⁶ |

Increasing oxidation at constant weight loading of carbon black showed an increase in measured volume resistivity of the compound of several orders of magnitude.

### Example 2

To understand the effect of weight load on the volumetric resistivity of the rubber composition, four different samples were prepared according to formulation shown in Table 3. Carbon black content has been adjusted between 64 phr and 180 phr to provide for carbon black having 30, 35, 30, and 45 wt% in the rubber composition. Two different carbon blacks were tested: i) ASTM type N550 (NSA=40 m²/g; OAN =121 cc/100 g), and ii) non-ASTM type BC1004 (NSA=25m²/g; OAN-95 cc/100 g). The formulations having a nascent carbon black and an oxidized carbon black were compared and the results are shown in Table 4.

TABLE 3
Rubber composition
EPDM Formulation

| Component | PHR |
|---|---|
| Vistalon 7500 | 100.0 |
| Carbon black | N |
| Sunpar 2280 | N × 0.61 |
| Zinc Oxide (Kadox 930C) | 4.0 |
| Stearic Acid | 1.5 |
| Altax/MBTS | 0.9 |
| Methyl Tuads (TMTD) | 1.7 |
| ZDBC (butyl zimate) | 0.9 |
| Sulfur (RM-90) | 2 |

N is adjusted between 64 phr and 180 phr to provide for 30, 35, 40, and 45 wt % of carbon black

TABLE 4
The Volume Resistivity of the Rubber Composition.

| | | Volume Resistivity, Ω · cm | | | |
|---|---|---|---|---|---|
| | CB, | N550 | N550 ox | BC1004 | BC1004 ox |
| Sample | wt % | (1% vol) | (3.6% vol) | (0.5% vol) | (3.2% vol) |
| Sample 4 | 30 | 2.2 × 10³ | 1.3 × 10⁷ | 4.5 × 10¹⁰ | 8.8 × 10¹² |
| Sample 5 | 35 | 6.5 × 10² | 1.5 × 10⁶ | 9.5 × 10⁵ | 8.3 × 10⁸ |
| Sample 6 | 40 | 1.1 × 10¹ | 6.5 × 10² | 9.3 × 10⁴ | 4.0 × 10⁷ |
| Sample 7 | 45 | 3.7 × 10⁰ | 2.9 × 10² | 1.2 × 10² | 6.9 × 10² |

It was shown that the use of BC1004 over N550 at equal loading results in a significant increase in volume resistivity. It was further shown that all cases of oxidation of the carbon black results in increases in volume resistivity and that the effect of oxidation is more pronounced in the ‘percolation’ region of carbon black loading.

### Example 3

It was found that the oxidation of carbon black can result in a drop in carbon black's pH. The rubber composition as shown in Table 5 was prepared to adjust the cure package acceleration system in order to broadly maintain mechanical properties of the oxidized and reference compounds.

TABLE 5
Rubber composition
EPDM Formulation

| Component | PHR |
|---|---|
| Vistalon 7500 | 100.00 |
| Carbon black | 95.00 |
| Sunpar 2280 | 51.00 |
| Zinc Oxide (Kadox 930C) | 5.00 |
| Stearic Acid | 1.00 |
| Altax/MBTS | 1.50 |
| ZDBC (butyl zimate) | 0.7/1.14 for |
| | oxidized compounds |
| Rhenocure ZAT (70%) | 1.14 |
| Rhenocure TP/G (50%) | 1.80 |
| Sulfur (RM-90) | 1.80 |
| Total | 262.24 |
| Carbon Black, wt % | 36.22 |

Table 6 shows various physical properties of the compound prepared accordingly to the formulation in Table 5 having carbon black with a various volatile content. It was shown that the compound properties other than volume resistivity of the rubber composition do not change substantially when non-oxidized carbon is replaced with the oxidized carbon.

TABLE 6
Compound properties as a function of various levels of oxidation.

| | N550-type | | BC1004-type | |
|---|---|---|---|---|
| | 1% | 2.5% | 0.5% | 2.1% |
| Compound property | (nascent) | (oxidized) | (nascent) | (oxidized) |
| Volume Resistivity, | 8.86 × 10¹ | 1.5 × 10⁵ | 1.3 × 10⁷ | 2.5 × 10⁹ |
| Q · cm | | | | |
| Mooney Viscosity. MU | 80.7 | 86.8 | 65.9 | 67.6 |
| Shore A Hardness | 64.0 | 65.9 | 56.7 | 59.4 |
| 100% Stress/MPa | 3.35 | 3.66 | 2.06 | 2.41 |
| 200% Stress/MPa | 6.81 | 7.22 | 4.26 | 4.66 |
| 300% Stress/MPa | 9.34 | 9.95 | 6.05 | 6.37 |
| Tensile Strength/MPa | 15.2 | 15.1 | 12.6 | 11.6 |
| Elongation % | 490 | 437 | 609 | 482 |

### Example 4

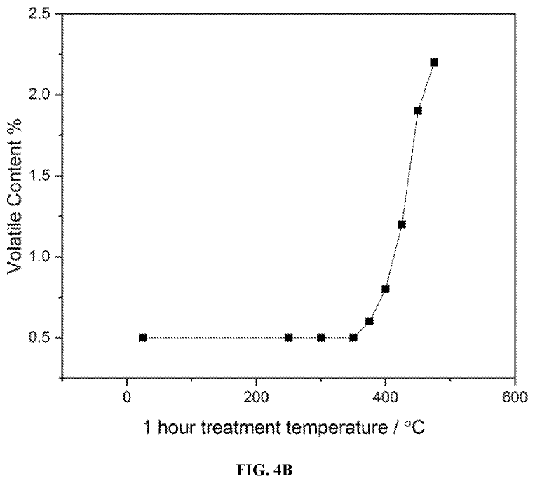

Effect of various types of carbon black oxidation on the volume resistivity of the rubber composition was tested. BC1004 carbon black was thermally oxidized. The effect of the oxidation temperature on the surface area of carbon black is shown in FIG. 4A. It was shown that at temperatures above 400° C., a sharp increase in the surface area was observed. Similarly a sharp increase in an amount of volatiles was observed when the oxidation temperature was above 400° C. (FIG. 4B). Without being bound by any theory, it was speculated that while providing the same content of volatiles as any other oxidation process, thermal oxidation potentially etches the surface of carbon black and introduces undesirable porosity that can affect the overall volume resistivity. The rubber composition comprising the thermally oxidized carbon black was prepared accordingly to a formulation shown in Table 7 and the volume resistivity results of such rubber in Table 8.

TABLE 7
Rubber composition
EPDM Formulation

| Component | PPHR |
|---|---|
| Vistalon 7500 | 100.0 |
| Carbon black | N |
| Sunpar 2280 | N × 0.61 |
| Zinc Oxide (Kadox 930C) | 4.0 |
| Stearic Acid | 1.5 |
| Altax/MBTS | 0.9 |
| ZDBC (butyl zimate) | 0.9 |
| Sulfur (RM-90) | 2 |

N is adjusted between 64 phr and 180 phr to provide for 35, 40, and 45 wt % of carbon black

TABLE 8
The Volume Resistivity of the Rubber Composition.

| | | Volume Resistivity, Ω · cm | | | |
|---|---|---|---|---|---|
| | CB, wt % | 0.5% vol | 1.2% vol | 1.9% vol | 2.2% vol |
| Sample | BC1004 | (nascent) | (425° C. 1 hr) | (450° C. 1 hr) | (475° C. 1 hr) |
| Sample 8 | 35 | 3.9 × 10¹⁰ | 3.5 × 10¹⁰ | 3.5 × 10¹⁰ | 2.1 × 10¹⁰ |
| Sample 9 | 40 | 4.3 × 10⁵ | 2.9 × 10⁵ | 8.6 × 10⁵ | 2.0 × 10⁶ |
| Sample 10 | 45 | 3.6 × 10² | 7.6 × 10² | 2.1 × 10² | 2.5 × 10⁴ |

It was shown that despite an increase in volatile content, no significant change in the volumetric resistivity of the rubber was observed.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

### E. ASPECTS

In view of the described rubber compositions and methods and variations thereof, herein below are described certain more particularly described aspects of the inventions. These particularly recited aspects should not however be interpreted to have any limiting effect on any different claims containing different or more general teachings described herein, or that the “particular” aspects are somehow limited in some way other than the inherent meanings of the language and formulas literally used therein.

Aspect 1: A rubber composition comprising a) an elastomer in an amount from about 100 phr; and b) an oxidized carbon black in an amount from about 25 to about 250 phr, wherein the oxidized carbon black comprises greater than 0% to about 4% of volatiles; and wherein the rubber composition has a volume resistivity from about 1×10² Ohm-cm to about lx10¹³ Ohm-cm.

Aspect 2: The rubber composition of aspect 1 further comprising a vulcanization accelerator in an amount from about 0.1 phr to about 5 phr.

Aspect 3: The rubber composition of aspect 1 or 2, wherein the rubber composition exhibits a substantially identical modulus measured at 100% to 300% tensile strain when compared to a substantially identical reference rubber composition.

Aspect 4: The rubber composition of aspect 1 or 2, wherein the rubber composition exhibits a modulus measured at 100% to 300% tensile strength that differs less than about 25% of a modulus measured at 100% to 300% tensile strength measured for a substantially identical reference composition.

Aspect 5: The rubber composition of any one of aspects 1-4, wherein the rubber composition exhibits a substantially identical tensile strength as compared to a substantially identical reference rubber composition.

Aspect 6: The rubber composition of any one of aspects 1-4, wherein the rubber composition exhibits a tensile strength that differs less than 25% of a tensile strength measured for a substantially identical reference rubber composition.

Aspect 7: The rubber composition of any one of aspects 1-6, wherein the rubber composition exhibits substantially identical elongation as compared to a substantially identical reference rubber composition.

Aspect 8: The rubber composition of any one of aspects 1-6, wherein the rubber composition exhibits an elongation that differs less than 25% of an elongation measured for a substantially identical reference rubber composition.

Aspect 9: The rubber composition of any one of aspects 1-8, wherein the rubber composition exhibits a substantially identical Mooney viscosity value when compared to a substantially identical reference rubber composition.

Aspect 10: The rubber composition of any one of aspects 1-8, wherein the rubber composition exhibits a Mooney viscosity value that differs less than 25% of a Mooney viscosity value measured for a substantially identical reference rubber composition.

Aspect 11: The rubber composition of any one of aspects 1-10, wherein the rubber composition exhibits a substantially identical Shore A hardness value when compared to a substantially identical reference rubber composition.

Aspect 12: The rubber composition of any one of aspects 1-10, wherein the rubber composition exhibits a Shore A hardness value that differs less than 25% of a Shore A hardness value measured for a substantially identical reference rubber composition.

Aspect 13: The rubber composition of any one of aspects 1-12, wherein the elastomer comprises at least one of natural rubber, nitrile rubber, neoprene, styrene-butadiene rubber, ethylene propylene diene monomer rubber, or any combination thereof.

Aspect 14: The rubber composition of any one of aspects 1-12, wherein the elastomer comprises ethylene propylene diene monomer rubber.

Aspect 15: The rubber composition of any one of aspects 1-14, wherein the oxidized carbon black is present in 10 wt% to about 50 wt % of the composition.

Aspect 16: The rubber composition of any one of aspects 1-15, wherein the oxidized carbon black has 0.5% to 3.5% volatiles.

Aspect 17: The rubber composition of any one of aspects 1-16, wherein the oxidized carbon black is obtained by ozone oxidation, thermal oxidation, peroxide oxidation, acid oxidation, or any combination thereof.

Aspect 18: The rubber composition of any one of aspects 1-16, wherein the oxidized carbon black is not obtained by a thermal oxidation.

Aspect 19: The rubber composition of any one of aspects 1-18, wherein the oxidized carbon black has an NSA value from about 20 to about 100 m².g⁻¹.

Aspect 20: The rubber composition of any one of aspects 1-19, wherein the starting material for the oxidized carbon black has an OAN value from about 40 to about 200 cc.100 g⁻¹

Aspect 21: The rubber composition of any one of aspects 1-20, wherein the percolation region of carbon black as measured prior to an oxidation is shifted by greater than 0 to about 100% after the carbon black is oxidized.

Aspect 22: The rubber composition of any one of aspects 1-21, wherein the oxidized carbon black exhibits a substantially identical porosity as compared to a non-oxidized carbon black having identical NSA and OAN values.

Aspect 23: The rubber composition of any one of aspects 1-22, wherein the rubber composition exhibits an increase in a volumetric resistivity of at least one order of magnitude when compared to a substantially identical reference composition.

Aspect 24: The rubber composition of any one of aspects 1-22, wherein the rubber composition exhibits an increase in a volumetric resistivity of at least two orders of magnitude when compared to a substantially identical reference composition.

Aspect 25: The rubber composition of any one of aspects 1-22, wherein the rubber composition exhibits an increase in a volumetric resistivity of at least four orders of magnitude when compared to a substantially identical reference composition.

Aspect 26: The rubber composition of any one of aspects 1-22, wherein the rubber composition exhibits an increase in a volumetric resistivity of at least six orders of magnitude when compared to a substantially identical reference composition.

Aspect 27: The rubber composition of any one of aspects 1-26, wherein the carbon black, prior to oxidation, comprises an ASTM grade carbon black.

Aspect 28: The rubber composition of any one of aspects 1-27, wherein the carbon black, prior to oxidation comprises a carbon black having a NSA value from 20 to about 100 m².g⁻¹ and an OAN value from about 40 to about 200 cc.100 g⁻¹.

Aspect 29: An article comprising the rubber composition of any one of aspects 1-28.

Aspect 30: The article of aspect 29, wherein the article comprises a hose, an anti-vibration component, an automotive sealing system, weatherstrip or profile component, a tire, or any combination thereof.

Aspect 31: A method comprising: (a providing an elastomer in an amount of about 100 phr; (b) providing an oxidized carbon black in an amount from about 25 to about 250 phr, wherein the oxidized carbon black comprises greater than 0% to about 4% of volatiles; and (c) mixing the elastomer and the oxidized carbon black to form a rubber composition having a volume resistivity from about 1×10² Ohm-cm to about 1×10¹³ Ohm-com.

Aspect 32: The method of aspect 31, wherein step of mixing comprises a reactive mixing.

Aspect 33: The method of any one of aspects 31 or 32, wherein the method further comprises providing about 0.1 to about 5 phr of a vulcanization accelerator prior to the step of mixing.

Aspect 34: The method of any one of aspects 31-33, wherein the oxidized carbon black is obtained by ozone oxidation, a peroxide oxidation, a thermal oxidation, an acid oxidation or any combination thereof.

Aspect 35: The method of any one of aspects 31-34, wherein the oxidized carbon black is not obtained by a thermal oxidation.

Aspect 36: The method of any one of aspects 31-35, wherein the oxidized carbon black is obtained by ozone oxidation.

Aspect 37: The method of claim of any one of aspects 31-36, wherein the rubber composition exhibits a substantially identical modulus measured at 100% to 300% tensile strain when compared to a substantially identical reference rubber composition.

Aspect 38: The method of any one of aspects 31-36, wherein the rubber composition exhibits a modulus measured at 100% to 300% tensile strain that differs less than about 25% of a modulus measured at 100% to 300% tensile strain for a substantially identical reference composition.

Aspect 39: The method of any one of aspects 31-38, wherein the rubber composition exhibits a substantially identical tensile strain as compared to a substantially identical reference rubber composition.

Aspect 40: The method of any one of aspects 31-38, wherein the rubber composition exhibits a tensile strength that differs less than 25% of a tensile strength measured for a substantially identical reference rubber composition.

Aspect 41: The method of any one of aspects 31-40, wherein the rubber composition exhibits substantially identical elongation as compared to a substantially identical reference rubber composition.

Aspect 42: The method of any one of aspects 31-40, wherein the rubber composition exhibits an elongation that differs less than 25% of an elongation measured for a substantially identical reference rubber composition.

Aspect 43: The method of any one of aspects 31-42, wherein the rubber composition exhibits a substantially identical Mooney viscosity value when compared to a substantially identical reference rubber composition.

Aspect 44: The method of any one of aspects 31-42, wherein the rubber composition exhibits a Mooney viscosity value that differs less than 25% of a Mooney viscosity value measured for a substantially identical reference rubber composition.

Aspect 45: The method of any one of aspects 31-44, wherein the rubber composition exhibits a substantially identical Shore A hardness value when compared to a substantially identical reference rubber composition.

Aspect 46: The method of any one of aspects 31-44, wherein the rubber composition exhibits a Shore A hardness value that differs less than 25% of a Shore A hardness value measured for a substantially identical reference rubber composition.

Aspect 47: The method of any one of aspects 31-46, wherein the elastomer comprises at least one of natural rubber, nitrile rubber, neoprene, styrene-butadiene rubber, ethylene propylene diene monomer rubber, or any combination thereof.

Aspect 48: The method of any one of aspects 31-46, wherein the elastomer comprises ethylene propylene rubber.

Aspect 49: The method of any one of aspects 31-48, wherein the oxidized carbon black is present in 10 wt% to about 50 wt % of the composition.

Aspect 50: The method of any one of aspects 31-49, wherein the oxidized carbon black has 0.5% to 3.5% volatiles.

Aspect 51: The method of any one of aspects 31-50, wherein the oxidized carbon black has an NSA value from about 20 to about 100 m².g⁻¹.

Aspect 52: The method of any one of aspects 31-51, wherein the starting material for the oxidized carbon black has an OAN value from about 40 to about 200 cc.100 g⁻¹.

Aspect 53: The method of any one of aspects 31-52, wherein the percolation region of carbon black as measured prior to an oxidation is shifted by greater than 0 to about 100% after the carbon black is oxidized.

Aspect 54: The method of any one of aspects 31-53, wherein the oxidized carbon black exhibits a substantially identical porosity as compared to a non-oxidized carbon black having identical NSA and OAN values.

Aspect 55: The method of any one of aspects 31-54, wherein the rubber composition exhibits an increase in a volumetric resistivity of at least one order of magnitude when compared to a substantially identical reference composition.

Aspect 56: The method of any one of aspects 31-54, wherein the rubber composition exhibits an increase in a volumetric resistivity of at least two orders of magnitude when compared to a substantially identical reference composition.

Aspect 57: The method of any one of aspects 31-54, wherein the rubber composition exhibits an increase in a volumetric resistivity of at least four orders of magnitude when compared to a substantially identical reference composition.

Aspect 58: The method of any one of aspects 31-54, wherein the rubber composition exhibits an increase in a volumetric resistivity of at least six orders of magnitude when compared to a substantially identical reference composition.

Aspect 59: The method of any one of aspects 31-58, wherein the carbon black, prior to oxidation, comprises an ASTM grade carbon black.

Aspect 60: The method of any one of aspects 31-59, wherein the carbon black, prior to oxidation comprises a carbon black having a NSA value from 20 to about 100 m².g⁻¹ and an OAN value from about 40 to about 200 cc.100 g⁻¹.

Aspect 61: A rubber composition prepared by the method of any one of aspects 31-60.

Aspect 62: An article comprising the rubber composition of aspect 61.

Aspect 63: The article of aspect 62, wherein the article comprises a hose, an anti-vibration component, an automotive weatherstrip component, a tire, or any combination thereof.

1. A rubber composition comprising
(a) an elastomer in an amount of 100 phr; and
(b) an oxidized carbon black in an amount from about 25 to about 250 phr,
wherein the oxidized carbon black comprises greater than 0% to about 4% of volatiles; and wherein the rubber composition has a volume resistivity from about 1×10² Ohm-cm to about 1×10¹³ Ohm-cm.

2. The rubber composition of claim 1 further comprising a vulcanization accelerator in an amount from about 0.1 phr to about 5 phr.

3. The rubber composition of claim 1, wherein the rubber composition exhibits a substantially identical modulus measured at 100% to 300% tensile strain when compared to a substantially identical reference rubber composition.

4. The rubber composition of claim 1, wherein the rubber composition exhibits a modulus measured at 100% to 300% tensile strength that differs less than about 25% of a modulus measured at 100% to 300% tensile strength measured for a substantially identical reference composition.

5. The rubber composition of claim 1, wherein the rubber composition exhibits a substantially identical tensile strength as compared to a substantially identical reference rubber composition.

6. The rubber composition of claim 1, wherein the rubber composition exhibits a tensile strength that differs less than 25% of a tensile strength measured for a substantially identical reference rubber composition.

7. The rubber composition of claim 1, wherein the rubber composition exhibits substantially identical elongation as compared to a substantially identical reference rubber composition.

8. The rubber composition of claim 1, wherein the rubber composition exhibits an elongation that differs less than 25% of an elongation measured for a substantially identical reference rubber composition.

9. The rubber composition of claim 1, wherein the rubber composition exhibits a substantially identical Mooney viscosity value when compared to a substantially identical reference rubber composition.

10. The rubber composition of claim 1, wherein the rubber composition exhibits a Mooney viscosity value that differs less than 25% of a Mooney viscosity value measured for a substantially identical reference rubber composition.

11. The rubber composition of claim 1, wherein the rubber composition exhibits a substantially identical Shore A hardness value when compared to a substantially identical reference rubber composition.

12. The rubber composition of claim 1, wherein the rubber composition exhibits a Shore A hardness value that differs less than 25% of a Shore A hardness value measured for a substantially identical reference rubber composition.

13. The rubber composition of claim 1, wherein the elastomer comprises at least one of natural rubber, nitrile rubber, neoprene, styrene-butadiene rubber, ethylene propylene diene monomer rubber, or any combination thereof.

14. (canceled)

15. (canceled)

16. (canceled)

17. (canceled)

18. The rubber composition of claim 1, wherein the oxidized carbon black is not obtained by a thermal oxidation.

19. (canceled)

20. (canceled)

21. The rubber composition of claim 1, wherein the percolation region of carbon black as measured prior to an oxidation is shifted by greater than 0 to about 100% after the carbon black is oxidized.

22. (canceled)

23. (canceled)

24. (canceled)

25. (canceled)

26. (canceled)

27. (canceled)

28. (canceled)

29. An article comprising the rubber composition of claim 1.

30. The article of claim 29, wherein the article comprises a hose, an anti-vibration component, an automotive sealing system, weatherstrip or profile component, a tire, or any combination thereof.

31. A method comprising:
(a) providing an elastomer in an amount of about 100 phr;
(b) providing an oxidized carbon black in an amount from about 25 to about 250 phr, wherein the oxidized carbon black comprises greater than 0% to about 4% of volatiles; and
(c) mixing the elastomer and the oxidized carbon black to form a rubber composition having a volume resistivity from about 1×10² Ohm-cm to about 1×10¹³ Ohm-cm.

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. A rubber composition prepared by the method of claim 31.

62. (canceled)

63. (canceled)
